(19) United States
(12) Patent Application Publication
(10) Pub. No.: US 2006/0224617 A1
(43) Pub. Date: Oct. 5, 2006

(54) Unstructured business metadata manager

(75) Inventor: William H. Inmon, Castle Rock, CO (US)

Correspondence Address: Marc Knittel;Fountainhead Law Group, Suite 509, 900 Lafayette St., Santa Clara, CA, 95050, US

(73) Assignee: Inmon Data Systems, Inc., Castle Rock, CO (US)

(21) Appl. No.: 11/397,592

(22) Filed: Apr. 3, 2006

Related U.S. Application Data
(60) Provisional application No. 60/667,953, filed on Apr. 4, 2005.

(51) Int. Cl. G06F 7/00

(52) U.S. Cl. 707/102

(57) ABSTRACT

Embodiments of the present invention include methods for collecting, organizing, storing and displaying business-oriented metadata. Business metadata is metadata that uses terms of business and is meaningful to the business person. Business Metadata Manager (BMM) is a software system that collects business metadata, organizes and categorizes it, stores it into a structure, such as tables of a database, and then allows business metadata to be displayed in response to a query from an analyst or end user.

### CROSS REFERENCE TO RELATED APPLICATIONS

This invention claims the benefit of priority from U.S. Provisional Application No. 60/667,953 filed Apr. 4, 2005, entitled “Unstructured Business Metadata Manager.”

### BACKGROUND

The present invention relates to metadata management, and in particular, to unstructured metadata management.

Unless otherwise indicated herein, the approaches described in this section are not necessarily all prior art to the claims in this application and are not admitted to be prior art by inclusion in this section.

Metadata is data about data. Technical metadata is that metadata that applies to the technical description of data and is of use to the technician. Business metadata is metadata that is couched in the terms of business and is meaningful to the businessperson. Business metadata has existed as long as business has existed and comes in many forms.

In order to understand business metadata, it is helpful to consider an example. Consider the number “7”. The number “7” by itself says very little. But when the notation “$” is added to “7”, now it is understood that “7” refers to seven dollars. Then the information is added that “7” appears in a newspaper and is placed next to the price of steaks, per pound. Now it is understood that steaks cost seven dollars per pound. Everything that is not “7” is business metadata. It is business metadata that supplies context to raw data to give that raw data meaning in the sense of business.

There are two types of metadata: technical metadata and business metadata. Technical metadata refers to information that applies to the technology that the data is housed in. As some examples of technical metadata, the length of a field, the name of a table, the name of a field, the indexes on a table are all forms of technical metadata. Technical metadata is for the technician and describes the technology that houses the data itself.

Business metadata can be divided into two broad categories: a business metadata term and an association. A business metadata term is just that, a term (i.e., a word or group of words such as a phrase having a particular meaning). An association of the term is some further description of some aspect of the business metadata term. There may be an association of the business metadata term for a description of the term, an association for the definition of the term, an association for ownership of the term, an association for any formula the term appears in, an association for where else the term appears, an association for where the term appears in a data model, and so forth.

Some of the common ways of classifying business metadata include associations by descriptions, definitions, a.k.a. (also known as), where-else-used (or where else found), other reports the business metadata is found in, formulas using the business metadata, the source of the business metadata, the targets where business metadata is used, ownership of the business metadata, relationships that the business metadata participates in, and so forth.

Business metadata has existed for a long time. But there is currently no utility to gather and organize business metadata and to allow for its interactive usage in the reporting and analysis environment.

To illustrate the importance and utility of business metadata it is useful to consider the dimensions of information that business metadata can add. Consider an analyst looking at a report. On the report the analyst sees some information about which there is some uncertainty. For example the analyst sees the word “revenue”. The analyst wishes to know what type of revenue is being reported on. Unfortunately, without some utility for analyzing the metadata, the analyst must continue the analysis. The analyst may wish to write down the word “revenue” and research it at a later point in time. But while the analyst is working, the analyst must continue down a linear path with no breaks in the thought process.

There have been parallel efforts for the collection and management of technical metadata. There have been data dictionaries, directories, repositories and other attempts to collect and manage technical metadata, but business metadata has been a neglected topic for the information processing community.

Thus, there exists a need for a method of accessing, viewing and managing business metadata, and in particular, to a method that may be used by an end user to access, manage and view business metadata interactively.

### SUMMARY

Embodiments of the present invention include methods of gathering, storing, and/or displaying business metadata. In one embodiment, the invention comprises two components: a gathering component, wherein various types of data are accessed, organized, collected, and/or stored, and a displaying component, wherein the business metadata that has been collected is made available to a user in an interactive manner or a standalone manner.

In one embodiment, sources of business data that are available for entry into the business metadata data gathering component include, but are not limited to, business metadata that is manually entered, business metadata that is entered in an automated manner through a predefined application program interface (API), business metadata from the Internet, and business metadata that comes from indexes that are created by examining an unstructured data source and pulling or retrieving business metadata from that source.

In another embodiment, business metadata associations are gathered from different sources. Various types of business metadata associations that are gathered include, but not limited to, descriptions, definitions, aka (also known as), where else found, other reports the business metadata found in, formulas using the business metadata, the source of the business metadata, the targets where business metadata are used, ownership of the business metadata, and relationships that the business metadata participates in, for example. Additional categories of business metadata associations may include other types of metadata associations. Thus, the forgoing list is to be understood as an example.

Once collected, the business metadata and the business metadata associations are stored in a business metadata warehouse. The business metadata warehouse may include business metadata terms (words or phrases); the types of associations of business metadata, the associated information itself, dates the business terms were first entered into the system, and so forth. There may be many occurrences of business terms and associations in the business metadata warehouse.

In one embodiment, once the business terms and associations are defined and stored in the business metadata warehouse, the business metadata, and associations are made available throughout the technological environment. There are many ways the business metadata may be made available. For example, the business metadata may be made available interactively. In this case the business metadata may be sent to a processor—a work station, a pc, a remote server—and a display component may be installed there. Alternatively, the business metadata may be made available locally on the same machine that the processor and the business metadata warehouse are stored. The business metadata may also be made available by means of a database call across a network.

In one embodiment, a business metadata display component can be separated from the business metadata warehouse and can be distributed separately.

In another embodiment, a business metadata display component has no necessary relationship with the reporting and analysis tools or information on which it operates. For example, an analyst operates on a reporting tool, and a display component has no necessary technological relationship with the reporting tool.

In one embodiment, the present invention includes a method of collecting and organizing metadata from one or more data sources. In another embodiment, metadata can be called-up interactively from a separate data analysis tool or directly from the business metadata manger itself. The display of business metadata may take the form of simple stand alone reports or as an interactive display while doing analysis and reporting. The interactive display of business metadata works with standard reporting and multi dimensional business intelligence tools and technology. In the interactive display of business metadata, the business metadata term that is of interest is located on the report or business intelligence tool, the term is highlighted or otherwise designated, the BMM then displays a selection screen which asks the user what type of business metadata is desired, and the business metadata is displayed. Upon displaying the business metadata that has been requested, the analyst is returned to the screen or report where the display of business metadata began.

In another embodiment, the present invention includes a method of managing business metadata comprising gathering business metadata; defining business metadata words or phrases; defining one or more associations for at least one of the business metadata words or phrases, wherein one or more associations describe the business metadata word or phrase; storing the business metadata words or phrases and associations in one or more tables of a database; and displaying the business metadata words or phrases and associations to a user.

In one embodiment, business metadata is gathered using a manual user interface.

In one embodiment, business metadata is gathered in an automated manner through a predefined API.

In one embodiment, business metadata is gathered from the Internet.

In one embodiment, business metadata is gathered from indexes.

In one embodiment, business metadata is gathered from a report.

In one embodiment, a business metadata word or phrase is selected manually, and in accordance therewith, one or more corresponding associations are displayed to the user.

In one embodiment, a business metadata word or phrase is selected from a report manually.

In one embodiment, a first software component is used for defining and storing the business metadata words and phrases and corresponding associations, and a second software component is used for displaying the business metadata words or phrases and associations.

In another embodiment, the present invention includes a method of managing business metadata comprising defining a business metadata word or phrase, defining one or more associations corresponding to the business metadata word or phrase, wherein the one or more associations describe the business metadata word or phrase, and storing the business metadata word or phrase and the one or more associations.

In one embodiment, the business metadata word or phase and one or more associations corresponding to the business metadata word or phrase are stored in linked tables of a database.

In one embodiment, defining the business metadata word or phrase comprises selecting text from an Internet, storing the selected text in a buffer, and designating one or more business metadata words or phrases in the selected text.

In one embodiment, defining the business metadata word or phrase comprises manually entering a business metadata word or phrase and corresponding association.

In one embodiment, the business metadata word or phrase is defined by an index of unstructured data.

In one embodiment, the business metadata word or phrase is defined by automatically reading a report.

In one embodiment, the method further comprises sending the business metadata word or phrase and the corresponding one or more associations across a network for display to a user.

In another embodiment, the current invention includes a method of managing business metadata comprising selecting one or more business metadata words or phrases; storing the one or more business metadata words or phrases defining one or more associations corresponding to at least one of said one or more business metadata words or phrases, wherein a particular association describes a particular business metadata word or phrase, storing the one or more associations; accessing one or more business metadata words or phrases and corresponding one or more associations, and displaying the accessed business metadata words or phrases and the corresponding one or more associations.

In one embodiment, one or more business metadata words or phrases are selected from a report.

In one embodiment, the report is generated from unstructured data.

In one embodiment, the report is generated from structured data.

In one embodiment, the one or more business metadata words or phrases and corresponding one or more associations are accessed using an external database call.

In one embodiment, the method further comprises sending one or more business metadata words or phrases and corresponding one or more associations across a network for display to a user.

The following detailed description and accompanying drawings provide a better understanding of the nature and advantages of the present invention.

### BRIEF DESCRIPTION OF THE DRAWINGS

FIG. 1 illustrates the flow of information using a business metadata manager according to one embodiment of the present invention.

FIG. 2 illustrates the data structure of 1:n relationships between business metadata terms and associations according to one embodiment of the present invention.

FIG. 3 illustrates an example screen for entering a business metadata term according to one embodiment of the present invention.

FIG. 4 illustrates an example screen for establishing a business metadata association according to one embodiment of the present invention.

FIG. 5 illustrates an example screen for entering a business metadata term according to one embodiment of the present invention.

FIG. 6 illustrates an example screen for managing business metadata according to one embodiment of the present invention.

FIG. 7 illustrates an example screen of an API interface.

FIG. 8 illustrates an example report that can interactively access business metadata terms and associations according to one embodiment of the present invention.

FIG. 9 illustrates an example screen for accessing business metadata associations according to one embodiment of the present invention.

FIG. 10 illustrates an example screen for entering a business metadata in a stand-alone configuration according to one embodiment of the present invention.

FIG. 11 illustrates calling on an external database from a business metadata manager according to one embodiment of the present invention.

### DETAILED DESCRIPTION

Described herein are techniques and methods for gathering, storing and/or displaying or otherwise managing business metadata. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In one embodiment, the present invention includes a Business Metadata Manager (“BMM”). Using the BMM, an analyst can go directly from a report to a BMM query that provides information about how attributes of the report (e.g., “revenue”) are derived. The analyst, using the BMM, has the opportunity to work in multiple dimensions. For this reason, not only is the analyst able to continue down the path of analysis, he is able to take side diversions into the deeper meaning of the analysis. Thus, the BMM opens up completely different channels of information and analysis for the information worker. Consequently, the BMM opens up a dimension of information that is not otherwise available.

In one embodiment, a BMM includes two components: the collection and organization of business metadata, and the interactive display of the business metadata at the point the end user is actually making an analysis. Of course, the business metadata can be accessed in a standalone manner as well as an interactive manner.

### Business Metadata Manager (BMM) Overview

Embodiments of the present invention include business metadata management software that may be used to capture, organize, store, and/or display business metadata. In particular, a BMM can display business metadata information on demand interactively and/or remotely. At the point that the end user is looking at analytical information, the BMM is able to provide business metadata information.

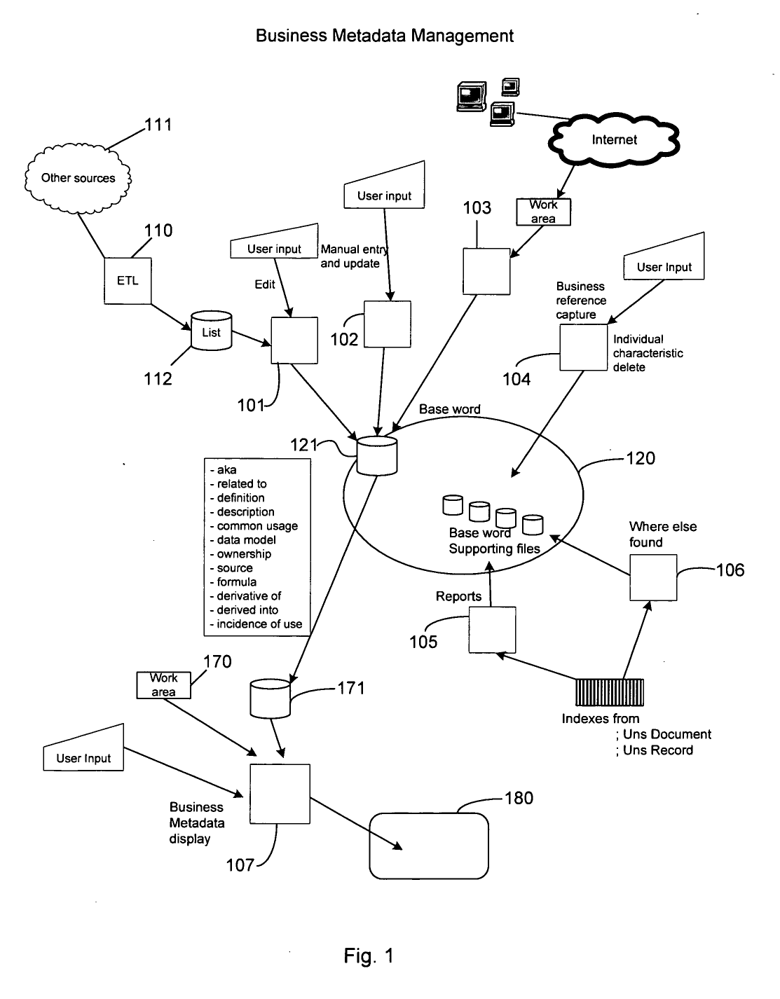

FIG. 1 illustrates the flow of information using a business metadata manager according to one embodiment of the present invention. In FIG. 1, it is seen that there are several program components that may be included in a BMM. These programs include an automated API interface program 101, a manual entry component 102 for manual update of business metadata words and phrases and the manual update of the associations of those words and phrases, an interface to the Internet 103, a component for deleting individual associations 104, an association reporter 105 that reports associations created from indexes created from reports, a component for managing unstructured associations 106 (e.g., “where else found”) created from indexes, and an end user display component 107 where the information in the business metadata databases is made available to an end user interactively.

The general flow in FIG. 1 shows that data starts to flow as it enters the system. There are four ways that data enters the system: manually, in an automated manner (i.e., automatically), via the Internet, and by reading special indexes prepared by reading reports and the unstructured data of a corporation. Once the data is entered into the system, it is organized, edited, and placed in one of a plurality of tables that make up the BMM infrastructure.

After the business metadata is placed in tables in a database 121, for example, the metadata is available for display and use by the end user. The end user can look at the data at an administrative workstation or the end user can look at the data on his/her own computer. The business metadata and its associations can be examined in an interactive manner by the end user as the end user is doing other analysis.

Programs that may be used in embodiments of the present invention are described below. It is to be understood that the partitioning of software components and the combined functionality of all the components together are only one example of the possible partitioning and functionality sets that may be used.

### API Interface

In FIG. 1, the API interface 101, is the automated API interface program. In this program data is read according to an API interface. Business metadata is stored electronically somewhere in the corporation in some format. A standard extraction-transformation-loading (“ETL”) tool 110 may be used to read the electronic business metadata and to map the business metadata into a format used by BMM. The format of the business metadata may be determined by the automated API. After the mapping has been done defining the source(s) 111 and target(s), the business metadata is read by the ETL tool and is written to a work area 112. Once the work area is prepared, the business metadata is then read into a screen generated by program 101. Program 101 may further filter out the business metadata. The screen asks if all business metadata is to be processed or if only existing business metadata is to be processed. If all business metadata is to be processed, the business metadata found in the work area results in the creation of a new business metadata word or phrase if one does not already exist. If only existing metadata is to be processed, then if a business metadata word or phrase exists in the work area that does not already exist in BMM, then no new business metadata word or phrase is created.

After the business metadata word or phrase coming from the work area has been processed, the associations which belong to the business metadata word or phrase are then processed. The association is placed in the correct table and the linkage to the business metadata word or phrase is established.

### Manual Entry Component

Manual entry component 102 is a collection of components (i.e., subroutines or programs) that serve the purpose of allowing data to be entered and manipulated into the BMM databases manually. Both business metadata words and phrases can be entered and associations can also be entered and manipulated.

The program allows a business metadata word or phrase to be entered. That word or phrase can then be entered or deleted from the BMM databases. In addition, associations can be entered and manipulated the same way. If it is desired to enter an association, first the business metadata word or phrase is entered. If the word or phrase exists, then the association can be entered. The association can be any of the many association types that belong to the business metadata word or phrase.

### Internet Interface

Program 103 is the interface to the Internet. Text can be captured by highlighting the text and placing the text in the buffer area for the Internet, for example. After the Internet buffer area is filled, the BMM module may be invoked. Upon invoking the BMM module, the screen is filled with the text that had been used to populate the Internet work area.

The next step is to designate the business metadata word or phrase. This can be done by manually writing the word or phrase in the appropriate box or by highlighting information from the text area and loading the input box from the highlighted value.

Now portions of the text can be highlighted and placed in the work area. Once in the work area, the text can be further edited and modified, if desired. Once the text in the work area is created and is ready, the text is then assigned an association type. The association type box is entered. Then the screen is activated and the data is loaded into the appropriate BMM database.

After the screen has been transacted, the work area is cleared and another part of the text can be highlighted. The process is repeated until the text has been fully processed.

### Association Delete

Sometimes it is necessary to delete a particular association. In 104, a particular association can be located and deleted.

### Association Reporter

Program 105 reads and loads report indexes into the BMM infrastructure. The report indexes are created by reading reports and pulling the business metadata off of those reports. The reports can come from the structured environment or the unstructured environment. The indexes contain the business metadata designation and the name, date, and other particulars of the report. The indexes are typically prepared before the screen will execute.

Upon entry to the screen, the user may be asked to indicate whether creation of business metadata words and phrases will be done. If the choice is to create business metadata words and phrases, then whenever an index is encountered that contains a business metadata word or phrase that has not been entered into the BMM environment, the screen causes an entry to be made into BMM for that business metadata word or phrase. If on the other hand, the end user chooses to not create a new business metadata word or phrase when one exists on the index but not in BMM databases, then that designation is made and no new business metadata words or phrases will be created.

When a match is made or when a new business metadata word or phrase is created, the report the business metadata term is found in is inserted as an association in the BMM infrastructure.

### Managing Unstructured Associations

Creating associations from unstructured data may also be provided by where-else-found (“WEF”) component 106. As data from the unstructured sources is read, unstructured data is examined and indexed. The unstructured data can be found anywhere in the corporation. The unstructured data can be of any type. As the unstructured data is read, an index is created. The index contains the information about the term that has been read. A second part of the index contains information about the document and the location of the document. These indexes may be created as a result of reading the unstructured data and processing it by an unstructured ETL product.

Once the unstructured processes are ready to be read, they can be processed by the BMM software. BMM reads the indexes. The software processes the indexes in the same manner as has been described for processing reports. If a business metadata term exists in the index but not in the BMM environment, then it is inserted only if the analyst wishes to do so.

After the business metadata word or phrase has been processed, the next step is to create an association. In one embodiment, the association may be created directly from the index.

### Interactive Display

Display 107 is designed to display the business metadata associations (e.g., on a request basis) to an interactive screen 180. Display 107 may be invoked while another report or screen is being examined.

In order to invoke interactive display screen 180, the user selects a word or phrase on the screen or report being examined by highlighting (i.e. selecting) the word or phrase. The word or phrase is then sent to work area 170. From work area 170 the word or phrase finds its way to the screen where it is displayed for the end user. Along with the word or phrase, the end user is asked to select an association type.

When the user selects an association type, the system then automatically determines if the word or phrase in fact has an association. If no associations exist for the word or phrase that has been selected for the association type that has been selected, then the system returns a message—“no association records found”. If the system does find one or more association records for the word or phrase that has been selected for the association type that has been selected, then the system displays the association information.

Upon displaying the association information, the end user is free to select another association type. If the end user does select another association type, the process repeats itself.

Upon completion of displaying association types for the word or phrase that has been selected, the system returns the analyst to the screen where the report or analysis that was originally in operation can continue.

One embodiment of the BMM may make a clear distinction between the administrative portion of the software and the display component of the software. Such an implementation may be useful because the display portion of the software can be run in a distributed mode. In a distributed mode, the BMM information is sent remotely to a processor along with an executable display module. For example, the information from the BMM may be stored in a database 171 for local access. Once the information and the module are sent to the software, they can be run independent of the administrative portion of the BMM technology. It is to be understood that other embodiments of the methods and techniques described herein may be implemented in a variety of other ways.

The administrative portion of the BMM software can be run in the administrative environment.

In one embodiment, the BMM data can be accessed by a database call from outside the environment. This allows users outside an administrative workstation or out of the distributed display module to access and use BMM data. Some embodiments may only allow updates to occur at the administrative work station.

In some embodiments, the end user display component can be independently distributed to a wide variety of computers and work stations.

### BMM Data Relationships

The business metadata that is found in the BMM environment may exist in a simple 1:n relationship. At the root is the business metadata word or phrase. Attached to a root is an association. An association is a description of some aspect of the business metadata word or phrase.

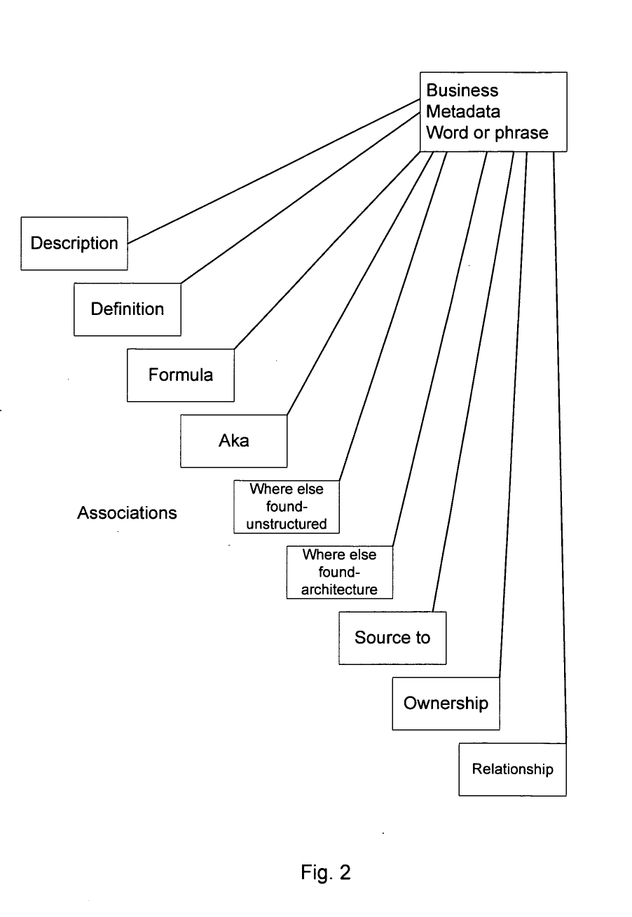

FIG. 2 illustrates the 1:n relationship between a term and its associations. If the business metadata word or phrase is deleted, then all associations that belong to the word or phrase are deleted. In other words, the associations need a business metadata word or phrase in order to exist.

For example, if there were a word—“expense”—that had an association of “formula,” if the word “expense” were deleted, the association of “formula” would also be deleted.

The associations shown in FIG. 2 are only a representative sample of the associations to business metadata words and phrases that are possible. For example, the association—“fact” is a possibility. In this case, “fact” would be some fact about a business metadata term or phrase.

The data structure that is shown in FIG. 2 can be implemented in a number of ways. For example, BMM may implement the business metadata relationship as a series of linked tables. Each table may include foreign key values that allow different tables to be linked. For example, in the table for business metadata words and phrases there is a key—“word”. Then in an association table there also exists the column for “word”. In the association table “word” refers to the corresponding word with the same value in the business metadata words and phrases table. In such a manner the two tables are logically linked together. It is to be understood that other implementations of the data structure are possible.

### Business Metadata Manager Operations

In one embodiment, a user of a Business Metadata Manager (BMM) may establish the infrastructure that business metadata runs on. The infrastructure may begin with the establishment of (i.e., by creating, defining, or specifying) the business metadata words that will be found in BMM. If a business metadata word is not found in the system, then associations and WEF indexes cannot be created. Therefore, a user may define which business metadata words or phrases are to be in the system. As previously mentioned, embodiments of the present invention may include business metadata “words” or “phrases.”

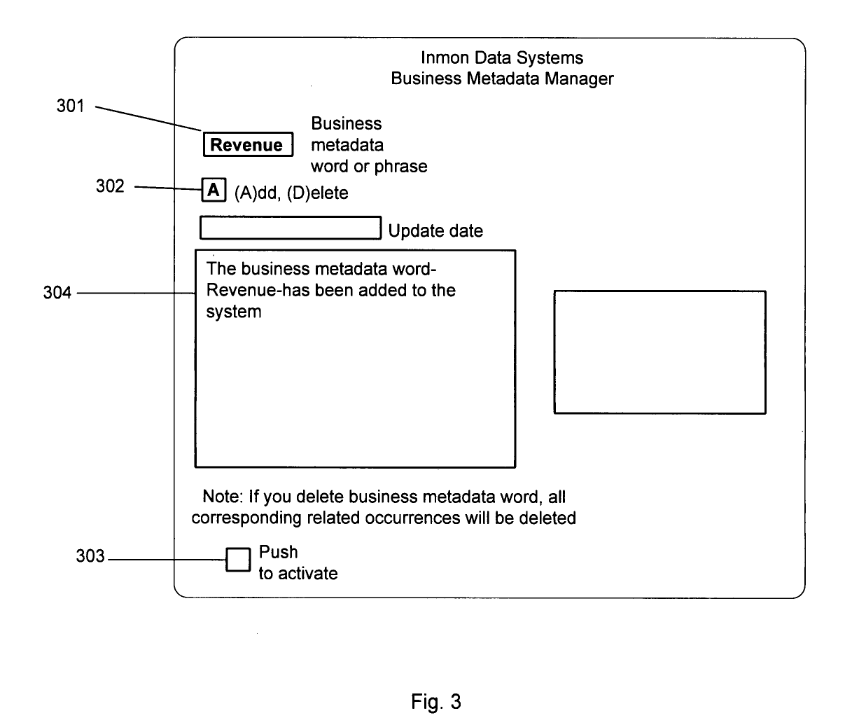

BMM may be installed on an administrative workstation, for example, and words and phrases can be defined in the system using the interface shown in FIG. 3. FIG. 3 illustrates how to insert a business metadata word or phrase into the system using a graphical user interface with prompts and data entry fields, The word or phrase is spelled out, placed into a screen (e.g., a graphical user interface), and entered.

A business metadata word or phrase is added to the system by entering it into box 301. After the business metadata word is entered, the action parameter 302 for the system is also entered—in this case an “A” to tell the system to add the word. The activate button 303 is then depressed and the system responds by acknowledging the entry of the business metadata word or phrase as shown in 304.

Once the business metadata word or phrase is added to the system, the word or phrase can have associations that relate to it added. There are many different kinds of associations that can be attached to a business metadata word or phrase. Some of the business metadata associations that can be added to a business metadata word or phrase include:
descriptions of the business metadata word or phrase;
definitions of the business metadata word or phrase;
where else found—where else in the unstructured environment the business metadata word or phrase can be found;
where else found—where else in the architecture the business metadata word or phrase can be found;
reports—what other reports reference or use the business metadata word or phrase;
aka—also known as—other names the business metadata word or phrase is known as
formula—formulas in which the business metadata word or phrase participates;
source to—where the business metadata word or phrase is a source to another business metadata word or phrase;
ownership—who (e.g., person or department) is responsible for the business metadata word or phrase;
source from—where did the business metadata word or phrase originate from;
relationship—what other business metadata words have a relationship to the established business metadata word or phrase

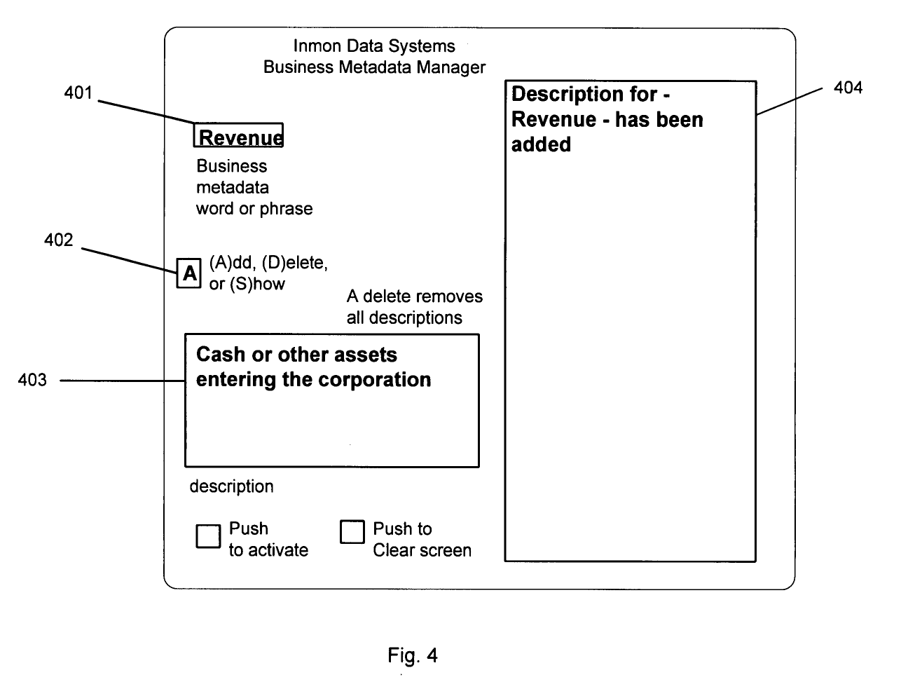

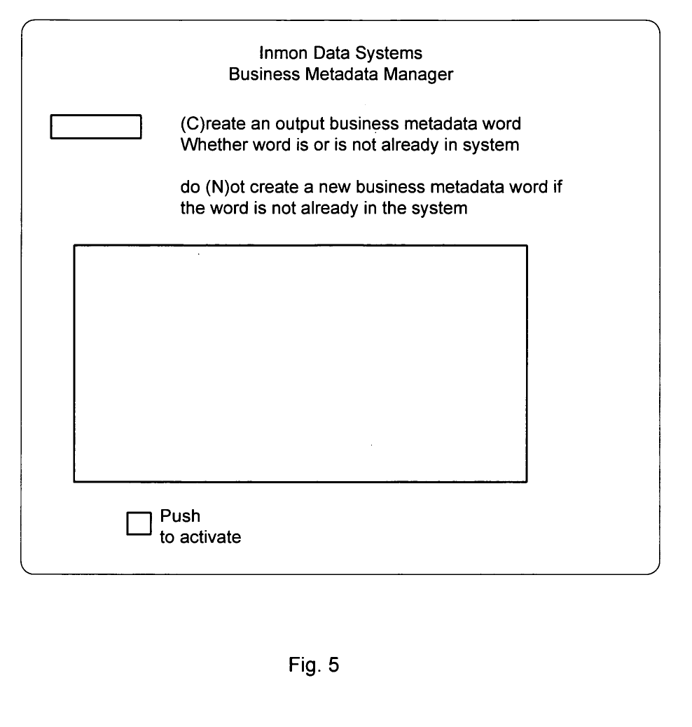

The associations can be established by using a screen (e.g., a graphical user interface) similar to that illustrated in FIG. 4. In order to enter an association, information may be entered into the screen as illustrated in boxes 401 and 403. Once the association is entered (e.g., in box 403, for description), and the action parameter 402 is set to “A”, the transaction is executed. The system may acknowledge the receipt of the association by the message shown in box 404. Note in 404 that the activity that has been shown is for description, one of the many association types for the business metadata word—“revenue”. The association that was added could have been for any of the association types. However, the “where else found” association types are typically added by reading an index prepared by unstructured ETL software. If the “where else found” (WEF) associations are added to the BMM, they may be read into the system in a separate transaction, which may be similar to the screen depicted in FIG. 5. This transaction is simple. The execution of this transaction may depend on the previous preparation of indexes by an unstructured ETL software product. The ETL software may have read a wide variety of unstructured words and phrases coming from a wide variety of sources. The unstructured data which has been processed by the ETL software includes, but is not limited to, .txt files or files that are readable as .txt files, .doc files, .pdf files, .xls files, email, email attachments, and .ppt files to name just a few.

Upon reading and processing the unstructured data, an index is created with the unstructured term and where the unstructured term has come from. BMM goes and reads the index. The only parameter needed for execution by BMM is that of telling whether or not a business metadata word or phrase needs to be created for each unstructured entry. Under normal circumstances if an index entry is found and there has been no business metadata term that has been established, the index entry will be passed and no activity will occur. For example, if the index entry is for the word—“expense”—and no business metadata word or phrase for “expense” has been added, then no business metadata term will be added. But if the end user specifies that for every index entry found, a business metadata word or phrase will be added if it doesn't exist, then business metadata words and phrases will be added. For example, if the end user specifies that business metadata terms are to be added, then if there is an index entry for “expense”, and no business metadata words or phrases for “expense” have been defined to the BMM system, then upon reading the index the word “expense” will be added to BMM.

For those matches made against the business metadata terms found in BMM or for those words or phrases that are added to BMM, a WEF entry as an association will be made. The WEF association merely tells where else the business metadata word or phrase is found. The index contains the information as to the location of the business metadata word or phrase.

The same type of processing is done for reports. The business metadata words and phrases found on reports can be collected by unstructured ETL processing and an index for those words and phrases can be constructed, just like the unstructured indexes were created as described above. Once the business metadata words and phrases for reports have been collected into an index, those index entries can be read and a BMM entry can be made. The reports whose business metadata words and phrases that are fed into the unstructured ETL process do not have to come from the unstructured environment. They can come from the structured environment as well.

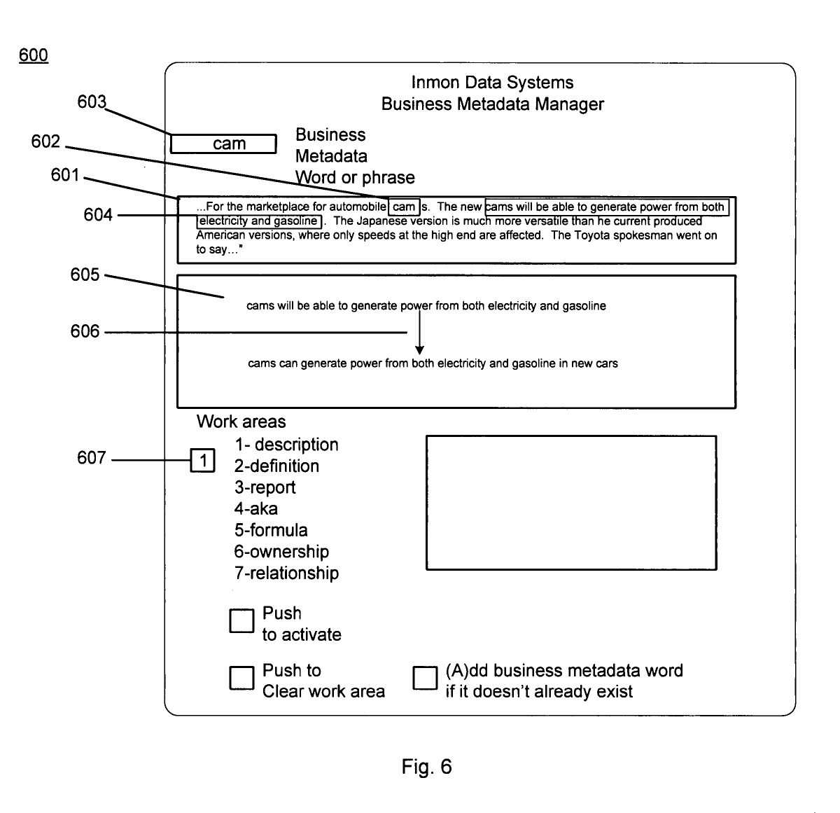

The third source for input into the BMM infrastructure is the Internet. The Internet can be read. Upon finding information from the Internet that would be useful in the BMM environment, the user merely highlights the text, sending the text to the Internet buffer or cache area. Then the end user invokes BMM with the screen designed for bringing in information from the Internet. That screen can look like screen 600 depicted in FIG. 6. This screen appears when information has been stored in the Internet caching area and BMM is invoked. The first thing that appears is the information that has been cached coming from the Internet as shown in 601. After the information found on the Internet is brought in from the Internet, the first thing to do is to select the business metadata word or phrase that will be used. This can be done by highlighting the business metadata word or phrase, as depicted in example in 602. Once the business metadata word or phrase 603 is selected, an appropriate association can be selected as illustrated in 604. Once text for the association is placed in the work area at 605, it can be edited as illustrated in the example depicted in 606. After the text in the work area is edited, the type of association that the text has with the business metadata word or phrase is selected as illustrated in the example depicted in 607. The transaction is executed and the association and the business metadata word or phrase is added to the BMM infrastructure. Of course if there are other business metadata words or phrases that have come from the Internet or if there are other associations that have come from the Internet, then those business metadata words or phrases or those associations can be added to the BMM infrastructure in the same way.

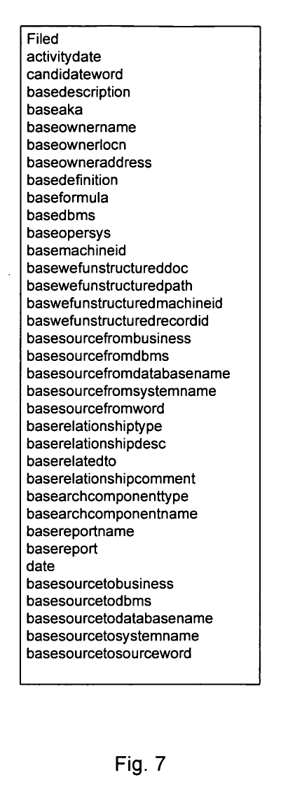

Another way that business metadata and the associations with business metadata can be entered into the BMM infrastructure is through the automated API interface. If the organization already has business metadata and associations captured electronically, the organization can enter the business metadata and associations in an automated manner. BMM may include an API interface that the data can be sent to. The end user may use an ETL tool to map the data into the format specified by the API. An example API is shown in FIG. 7.

The end user starts with his/her electronic data. The data can be mapped to the API through a standard ETL tool, for example. The mapping is such that if no association data exists for a business metadata word or phrase, then no associations are mapped. The only associations that are mapped are those that are present in the electronic source. As a result it is normal for a mapping to contain a significant amount of null data.

Of course, multiple API records may be created for the same business metadata word or phrase. When there are multiple associations for the same business metadata word or phrase, there will be multiple API records that are created.

After the mappings are done, then the data is read from the electronic source and a new data set is created conforming to the BMM API for automated entry.

After the new data set is created, the next step is to feed the newly formatted data into the BMM infrastructure. This may be done by using the example API interface screen that was shown in FIG. 5. FIG. 5 shows a blank screen for manually entering new metadata with the options to either create or not create a duplicate metadata word if the word already happens to exist in the system. This screen looks the same as the WEF screen and operates in a similar manner. If the analyst wishes to create a new business metadata word or phrase in the BMM infrastructure when reading the electronic API file, then the analyst enters a “C”, for create. If the analyst does not wish to create a new business metadata word or phrase when reading the electronic API file upon the occasion of reading a business metadata word or phrase in the electronic API file that does not already exist in the BMM infrastructure, then the analyst enters “N”.

Upon reading the electronic API file, when the reading program senses a null value for an association, no association is created. But when the analyst finds an association in the electronic API file record, the association is created for the business metadata word or phrase that belongs to the record. Thus, in such a manner, data may be loaded into the BMM infrastructure automatically.

Accordingly, four example methods of loading business metadata and their associations into the BMM infrastructure include: manually, through the Internet interface, through the reading of WEF indexes created by an unstructured ETL tool, and through an automated API interface.

Once data is in the BMM environment, it can be edited and/or deleted. In particular, business metadata words or phrases can be deleted and associations can be deleted. If a business word or phrase is deleted, then, all associations that belong to the business metadata word or phrase are also deleted. Or all the associations of a given type can be deleted for a given business metadata word or phrase. For example, suppose there is a business metadata word—“expense”—that has been defined for BMM. Now suppose that there are several descriptions for expense. Expense descriptions are a form of an association. All of the descriptions for “expense” could be deleted, without deleting “expense”. A third alternative is to select only one description of “expense” and to delete it.

When it comes to associations, it is then possible to delete a business metadata term or phrase which deletes all associations, it is possible to delete all associations of a single type for a business word or phrase, or it is possible to delete only a single occurrence of a particular association.

Once the business metadata words and phrases and the associations that belong to them are placed in the BMM infrastructure, the BMM infrastructure is ready to be viewed.

The information found in the BMM infrastructure can be viewed or accessed in a variety of ways. For example, the information can be viewed at the administrative work station, the information can be displayed as a result of database calls to the administrative work station, or the information can be viewed by means of the distribution of an end user contents display (“EUCD”) package. The most normal usage of the BMM data is by the EUCD package, which is distributed.

The EUCD package may comprise of two basic components: (1) the business metadata and the associations that reside in the administrative work station and (2) an executable display module.

In order to see how the EUCD package operates, it is helpful to consider the following scenario. One day an end user approaches the business metadata manager, or whoever is in charge of managing the business metadata administrative workstation. The end user asks for a EUCD package. The administrator then sends a copy of the business metadata and the executable display module to the end user. The end user may be on a network, For example. The end user may have only a laptop personal computer that is not attached to any network. In fact, the end user can have almost any configuration of processor.

Once the end user receives the data and the executable display module from the administrator, the end user then loads the data and the executable display module on his/her computer.

Once the data and the executable display module have been loaded onto the end users computer, the end user is ready to operate.

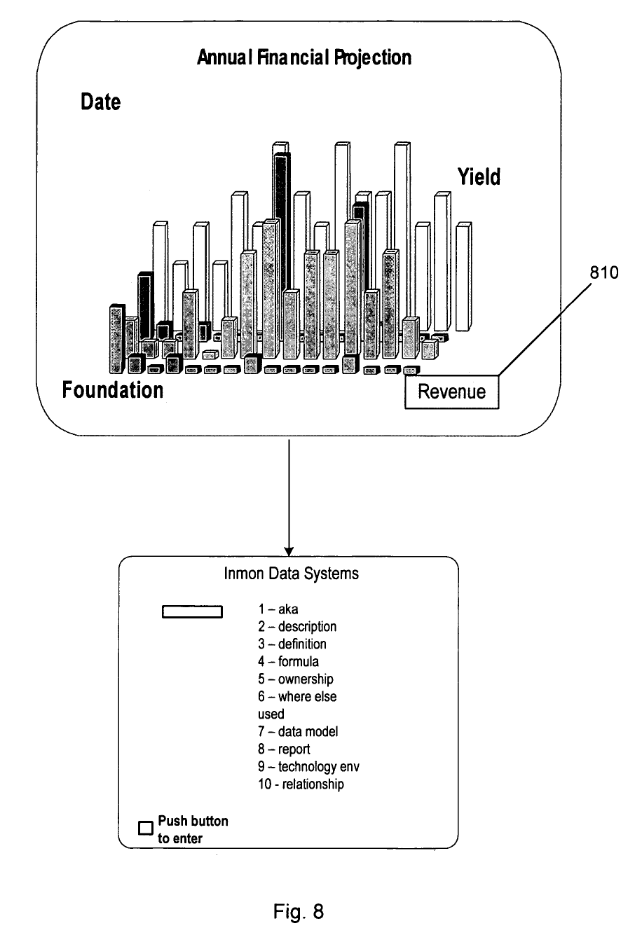

Now, suppose the end user is doing an analysis and has a report 800 displayed on his/her computer similar to the screen depicted in FIG. 8. The report could be from any number of pieces of software—SAS, Cognos, Crystal Reports, Business Objects, Micro Strategy, Siebel, SAP, PeopleSoft and so forth. There is no restriction or other qualification as to what software is being presented or used. BMM is independent of the underlying analytical or reporting software.

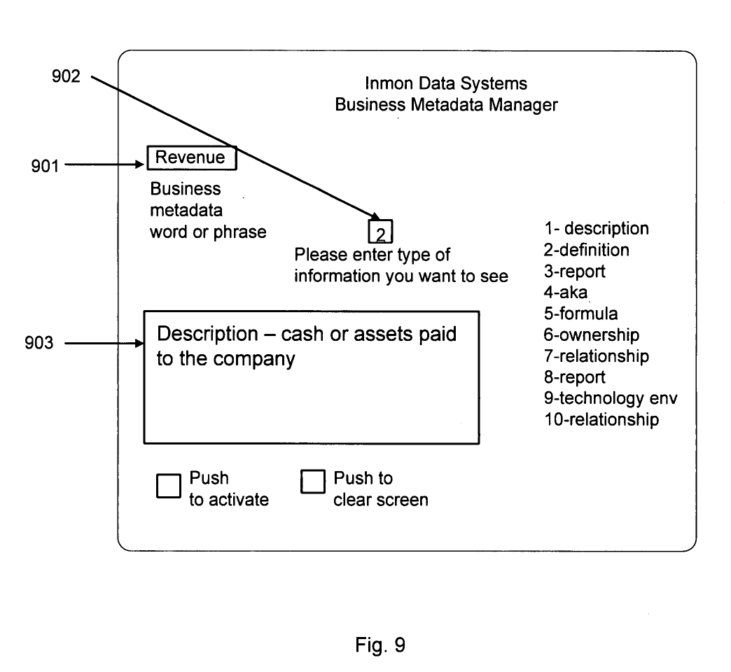

Upon looking at the report, the end user sees something about the report that strikes his/her fancy. The end user sees a term on the report that the end user wants to find out more about. The end user then highlights the word that is of interest. For example, a user may select or highlight “Revenue” 810 on report 800. After highlighting the word or phrase that is of interest, BMM executable display module is invoked. When it is invoked a general display screen 820 may appear. Screen 820 may be used for the purpose of selecting what associations of the business metadata will be needed. The word that has been highlighted may appear on screen 900 at 901 from BMM executable display module as shown in FIG. 9. The next step is for the analyst to choose what type of business metadata association that is needed as shown in 902. Once the type of association has been selected, the screen is activated. At this point, the system goes to the business metadata words and phrases and seeks out the business metadata word or phrase that has been selected. If the system does not find the word or phrase among the data it has, it returns a message—“cannot find the word”. If the system can find the business metadata word or phrase, but cannot find the association, the system returns a message—“found the word but there are no associations”. If the system can find the business metadata word and can find one or more associations of the type that have been requested, the system returns the appropriate information, as shown in the example depicted in 903 for “description.” Of course, if there are multiple occurrences of an association that has been requested, then those occurrences are displayed as well. If the end user wishes to look at other associations then the display screen allows him/her to do so. When the user is finished reviewing the business metadata, the end user is returned to his or her original report, as shown in FIG. 8. Thus, the end user has the ability to interact with the report and analysis that is being done in an interactive manner.

Note that the end user in the distributed EUCD case may not have the ability to add, update, edit, or delete any information found on the end users computer. The end user may only have the ability to display information. If it is desired to have an update of business metadata information, the end user may have to notify the administrator of the need for update or additions to the business metadata BMM environment.

While the EUCD approach is one way the BMM may be used, it is not the only way BMM can be used. In another embodiment, BMM technology can be used is by database calls to the administrative workstation.

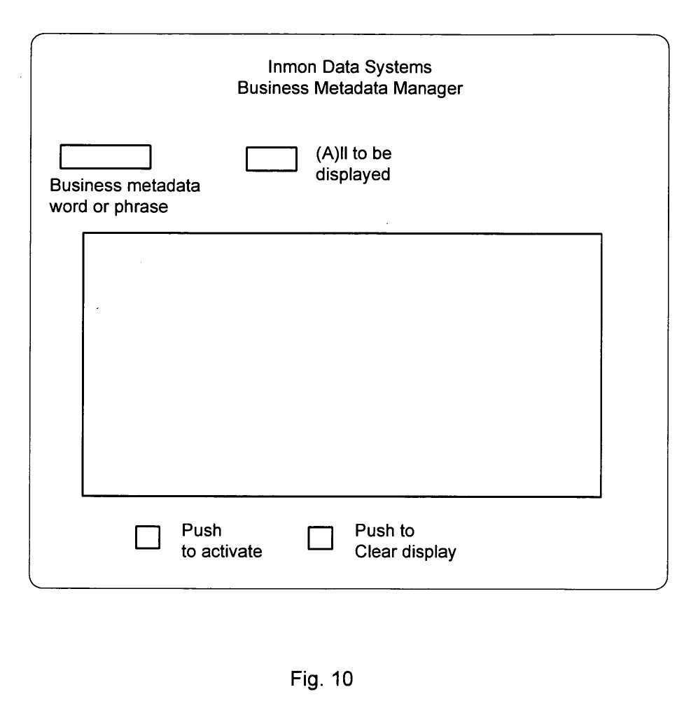

In another embodiment, business metadata can be accessed through BMM in a standalone manner. In this case, there is a screen which is available at the administrative work station. This screen may look like the example screen depicted in FIG. 10. The usage of this screen starts with the entry of the business metadata word or phrase that is desired. An alternative is to look at all information in the BMM infrastructure. When the screen is activated, the system goes and finds the data that has been requested. If the end user has requested a single word or phrase, then the system searches for that word or phrase. If the system cannot find the word or phrase, the system returns a message—“business metadata word or phrase cannot be found”. If the system can find the business metadata word or phrase, the system returns the word or phrase along with the associations that belong to the word or phrase.

If the end user has specified all the words and phrases to be displayed, then the system returns all the words and phrases along with their associations.

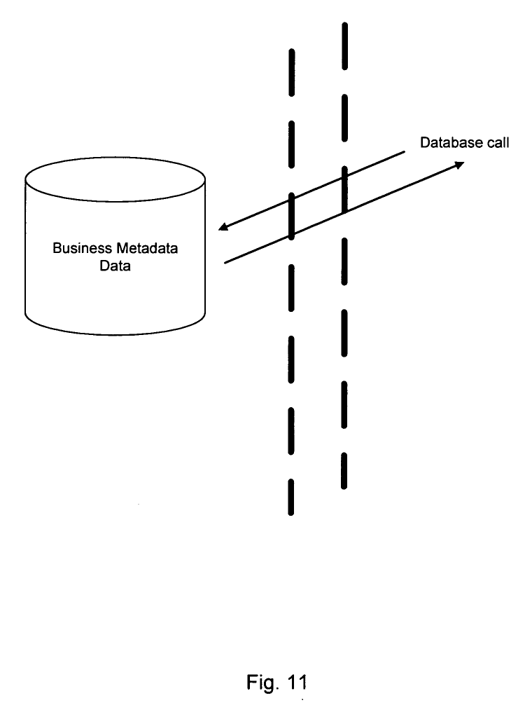

There may be occasions where EUCD cannot be implemented and where business metadata is needed outside of the administrative workstation. In this case, business metadata in the BMM environment can still be accessed. For example, a simple database call may be executed to the business metadata words and phrases and to the associations. Such a call is illustrated in FIG. 11. The database call can be made from a wide variety of places—other programs in the administrative work station, the network, other servers, and so forth. The business metadata may remain in the database to be accessed.

### Business Metadata Words

The present invention recognizes that business metadata needs to be treated and managed in a special and more efficient manner. Almost any word can be business metadata, depending on the business and the context. However certain terms are common business metadata found throughout industry. The following list identifies some of the words. Note that the list is only a few of the universe of commonly found business metadata terms.

| | | | |
|---|---|---|---|
| Profit | Sale | Payment | Inventory |
| Quarterly | date | Amount | Amount |
| Annual | Item | Date | Type |
| Expense | Location | Due date | Spoil date |
| Quarterly | On sale | Interest | Cost |
| Annual | Tax | Account | Sale |
| Monthly | salesperson | Name | Location |
| Fixed | Product | Number | Container |
| Recurring | Sold | Amount | Raw good |
| Non recurring | Ordered | Date opened | Work in progress |
| One time | Shipped | Date closed | Finished good |
| Extraordinary | Backlog | Active | Packaging |
| Revenue | On hand | Inactive | Storage footprint |
| Quarterly | Production | Commercial | Department |
| Annual | Rate | Retail | Marketing |
| Actual | Scheduled | Balance due | Sales |
| Budgeted | In progress | Interest | Engineering |
| Departmental | Customer | Taxable | Human |
| Corporate | Potential | Terms | resources |
| Extraordinary | Actual | Loan | Accounting |
| Recurring | Former | Amount | Finance |
| Non recurring | Active | Date | Quality control |
| By product | Inactive | Cosigner | Production |
| By state | High end | Collateral | Development |
| By country | Low end | Insured | Budget |
| By region | Order | Address | Item |
| By sales territory | Placed | Name | Amount |
| By zip code | Anticipated | Policy number | Proposed |
| Sales | Backlog | Registration | Approved |
| Annual | In progress | Number | Type |
| Quarterly | Linked | Date | Currency |
| Monthly | Shipment | Credit card | $ (American) |
| Regional | Made | Balance | $ (Canadian) |
| Departmental | Planned | Interest | $ (Australian) |
| Total | Scheduled | Due date | E (symbol for |
| Projected | Late | Number | Euro) |
| Actual | On time | Pin | L (symbol for |
| Booked | Insurance policy | Flight | English pound) |
| Closed | In force | Date | Y (symbol for Japanese Yen) |
| Pipeline | Expired | Number | Sales Pipeline |
| Budgeted | Expiration date | Plane type | Entry date |
| Regional | Claim | Seat | Name |
| By product | Date | First class | Status |
| By sales territory | Amount | Cargo | Projected |
| By country | Reason | Destination | Revenue |
| By state | Agent | Origination | Asset |
| By salesperson | Claim office | SKU | Debt |
| By quota | Shares | Amount | Outstanding stock |
| By zip code | Book to bill ratio | Date | Equity |
| | | Price | |

This list is only a very small representation of what can be construed as business metadata. Each business will have its own unique and particular key performance indicators and measures of what is important to the business.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method of managing business metadata comprising:
gathering business metadata;
defining business metadata words or phrases;
defining one or more associations for at least one of the business metadata words or phrases, wherein the one or more associations describe the business metadata word or phrase;
storing the business metadata words or phrases and associations in one or more tables of a database; and
displaying the business metadata words or phrases and associations to a user.

2. The method of claim 1 wherein business metadata is gathered using a manual user interface.

3. The method of claim 1 wherein business metadata is gathered in an automated manner through a predefined API.

4. The method of claim 1 wherein business metadata is gathered from the Internet.

5. The method of claim 1 wherein business metadata is gathered from indexes.

6. The method of claim 1 wherein business metadata is gathered from a report.

7. The method of claim 1 wherein a business metadata word or phrase is selected manually, and in accordance therewith, one or more corresponding associations are displayed to the user.

8. The method of claim 7 wherein a business metadata word or phrase is selected from a report manually.

9. The method of claim 1 wherein a first software component is used for defining and storing the business metadata words and phrases and corresponding associations, and a second software component is used for displaying the business metadata words or phrases and associations.

10. A method of managing business metadata comprising:
defining a business metadata word or phrase;
defining one or more associations corresponding to the business metadata word or phrase, wherein the one or more associations describe the business metadata word or phrase; and
storing the business metadata word or phrase and the one or more associations.

11. The method of claim 10 wherein the business metadata word or phase and the one or more associations corresponding to the business metadata word or phrase are stored in linked tables of a database.

12. The method of claim 10 wherein defining the business metadata word or phrase comprises selecting text from an Internet, storing the selected text in a buffer, and designating one or more business metadata words or phrases in the selected text.

13. The method of claim 10 wherein defining the business metadata word or phrase comprises manually entering a business metadata word or phase and corresponding association.

14. The method of claim 10 wherein the business metadata word or phrase is defined by an index of unstructured data.

15. The method of claim 10 wherein the business metadata word or phrase is defined by automatically reading a report.

16. The method of claim 10 further comprising sending the business metadata word or phrase and the corresponding one or more associations across a network for display to a user.

17. A method of managing business metadata comprising:
selecting one or more business metadata words or phrases;
storing the one or more business metadata words or phrases;
defining one or more associations corresponding to at least one of said one or more business metadata words or phrases, wherein a particular association describes a particular business metadata word or phrase;
storing the one or more associations;
accessing one or more business metadata words or phrases and corresponding one or more associations; and
displaying the accessed business metadata words or phrases and the corresponding one or more associations.

18. The method of claim 17 wherein the one or more business metadata words or phrases are selected from a report.

19. The method of claim 18 wherein the report is generated from unstructured data.

20. The method of claim 18 wherein the report is generated from structured data.

21. The method of claim 17 wherein the one or more business metadata words or phrases and corresponding one or more associations are accessed using an external database call.

22. The method of claim 17 further comprising sending one or more business metadata words or phrases and corresponding one or more associations across a network for display to a user.
